(19) United States
(12) Patent Application Publication
(10) Pub. No.: US 2017/0351835 A1
(43) Pub. Date: Dec. 7, 2017

(54) DISRUPTION ASSESSMENT TOOL

(71) Applicant: Accenture Global Solutions Limited, Dublin (IE)

(72) Inventors: Tawfik Jarjour, Sugar Land, TX (US); Marc A. Warren, Chicago, IL (US); Drew Boston, Chicago, IL (US); Joshua Tauber, New York, NY (US); Timothy Schulte, Chicago, IL (US); Vishrut Prakash Srivastava, Hermosa Beach, CA (US); Dipak Patel, Chicago, IL (US); Alan W. Nalle, Atlanta, GA (US); Pranitha Patil, Chicago, IL (US); Sama Kadakia, Nashua, NH (US)

(21) Appl. No.: 15/174,642

(22) Filed: Jun. 6, 2016

(51) Int. Cl. G06F 19/00; G06Q 50/00; G06Q 30/02

(52) U.S. Cl. CPC G06F 19/3431; G06Q 30/0203; G06F 19/3425; G06Q 50/01

(57) ABSTRACT

Methods, systems, and apparatuses, including computer programs encoded on a computer storage medium, can be implemented to perform actions for capturing assessments. The actions can include receiving data that is related to an entity from one or more sources, processing one or more portions of the data to provide one or more analyses associated with the one or more portions of the data, generating a user interface that displays one or more portions of the data in association with the one or more analyses and a section for assessing the entity, outputting the user interface to a processing device for display of the section and display of the one or more portions of the data in association with the one or more analyses, receiving an assessment of the entity from the user interface, and storing the assessment in association with the entity.

### BACKGROUND

An entity within an industry may desire to examine other entities within the industry in efforts to meet continually evolving industry demands and to improve a standing within the industry. In some examples, the entity may gather information about the other entities or seek consultation or expertise about the other entities in order to inform strategic decisions. In some cases, decision-makers associated with the entity may focus the strategic decisions on innovative capabilities that can disrupt typical practices and behaviors within the industry. In some examples, innovative capabilities are examined to effect strategic decisions for entities in a variety of industries.

### SUMMARY

Implementations of the present disclosure are generally directed to a computer-implemented framework for processing data reflecting sentiments about disruptive entities within an industry in order to inform strategic decisions that can impact the industry. For example, implementations of the present disclosure include computer-implemented methods for capturing assessments of disruptive entities. The computer-implemented methods are executed by one or more processors and include the actions of receiving data that is related to an entity from one or more sources, processing one or more portions of the data to provide one or more analyses associated with the one or more portions of the data, generating a user interface that displays one or more portions of the data in association with the one or more analyses and a section for assessing the entity, outputting the user interface to a processing device for display of the section and display of the one or more portions of the data in association with the one or more analyses, receiving an assessment of the entity from the user interface, the assessment being usable for characterizing the entity, and storing the assessment in association with the entity. Other implementations of the present disclosure include corresponding systems, apparatuses, and computer programs encoded on computer storage devices that are configured to perform the actions of the computer-implemented method.

These and other implementations can each optionally include one or more of the following features. In some implementations, the entity is a disruptive entity. In some implementations, the entity is a digital health entity. In some implementations, the one or more sources include a database, a webpage, and information provided by a user. In some implementations, the section includes a rating selector. In some implementations, the rating selector is a binary rating selector. In some implementations, the section includes a comment window. In some implementations, the section includes a special designation selector. In some implementations, the processing includes assigning one or more categories to the entity, the data includes the one or more categories, and the one or more analyses includes an assignment of the one or more categories.

In some implementations, the actions further include generating scores of the entity and generating a graphical display representing the scores, the data includes the scores, and the one or more portions of the data displayed in the user interface includes the graphical display. In some implementations, the graphical display includes a scoring matrix. In some implementations, the data includes profile information related to the entity, and the one or more portions of the data included in the user interface include the profile information. In some implementations, the data includes financial information related to the entity, the actions further include generating a graph based on the financial information, and the one or more portions of the data displayed in the user interface includes the graph. In some implementations, the graph includes a bar graph, a bar-line graph, an information map, or a chart.

In some implementations, the user interface is a front-end user interface, and the actions further include generating a back-end user interface displaying one or both of user profile data associated with the assessment and aggregated statistics based on the assessment. In some implementations, the assessment is based on the one or more portions of the data displayed in the user interface. In some implementations, the assessment includes a positive rating or a negative rating. In some implementations, the data is received according to a predetermined schedule. In some implementations, the actions further include receiving multiple assessments of respective entities, and generating aggregate statistics based on the multiple assessments.

In accordance with implementations of the present disclosure, techniques are employed to provide profile information associated with disruptive entities to capture (e.g., crowdsource) assessments of the disruptive entities based on the profile information and to generate or augment an information base (e.g., a reference base or a knowledge base) including the assessments. The information base can provide decision-makers within an industry with insights that may inform important strategic decisions than can influence development within the industry.

Furthermore, implementations of the present disclosure include techniques to retrieve raw data from a data repository, generate processed data from the raw data, store the processed data in a data repository, and retrieve the processed data, as opposed to repeatedly retrieving the raw data from the data repository and reprocessing such data. In this manner, implementations of the present disclosure improve a processing speed (e.g., an amount of time required to output a desired result) of a computing system on which the techniques are implemented.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### BRIEF DESCRIPTION OF DRAWINGS

FIG. 1 depicts an example computing system that can execute implementations of the present disclosure.

FIG. 2 depicts an example disruption assessment tool in accordance with implementations of the present disclosure.

FIG. 3 depicts scoring tables in accordance with implementations of the present disclosure.

FIG. 4 depicts an example scoring matrix in accordance with implementations of the present disclosure.

FIG. 5 depicts an example bar-line graph in accordance with implementations of the present disclosure.

FIG. 6 depicts an example bar graph in accordance with implementations of the present disclosure.

FIG. 7 depicts an example information map in accordance with implementations of the present disclosure.

FIG. 8 depicts an example bar graph in accordance with implementations of the present disclosure.

FIG. 9 depicts an example front-end user interface in accordance with implementations of the present disclosure.

FIG. 10 depicts an example front-end user interface in accordance with implementations of the present disclosure.

FIG. 11 depicts an example front-end user interface in accordance with implementations of the present disclosure.

FIG. 12 depicts an example back-end user interface in accordance with implementations of the present disclosure.

FIG. 13 depicts an example back-end user interface in accordance with implementations of the present disclosure.

FIG. 14 depicts an example back-end user interface in accordance with implementations of the present disclosure.

FIG. 15 depicts an example process that can be executed in implementations of the present disclosure.

FIG. 16 depicts an example computing system that can execute implementations of the present disclosure.

### DETAILED DESCRIPTION

Implementations of the present disclosure are generally directed to a computer-implemented framework for processing data reflecting sentiments about disruptive entities within an industry in order to inform strategic decisions that can impact the industry. For example, techniques are employed to provide profile information associated with disruptive digital health entities, to capture (e.g., crowdsource) assessments of the disruptive digital health entities based on the profile information, and to generate or augment an information base (e.g., a reference base or a knowledge base) including the assessments. The information base can provide decision-makers within the healthcare industry with insights that may inform important strategic decisions than can influence digital health initiatives within the healthcare industry.

More particularly, implementations of the present disclosure are directed to a disruption assessment tool (e.g., a tool that captures assessments about disruptive digital health entities). In some examples, the disruption assessment tool generates and outputs front-end user interfaces that can be used to capture the assessments. Upon receiving the assessments from the front-end user interfaces, the disruption assessment tool stores the assessments within a data repository. In some examples, the disruption assessment tool generates and outputs back-end user interfaces that present analyses of the assessments and analyses of user profile data associated with the assessments. In some implementations, the analyses can inform back-end users with insights to effect strategic decisions and can allow back-end users to assess a usefulness, a popularity, or an effectiveness of the disruption assessment tool.

Implementations of the present disclosure are described herein in a non-limiting, example context that includes the healthcare industry. More particularly, implementations of the present disclosure are described herein in detail with reference to an example assessment tool that can be used to capture assessments of disruptive digital health entities. It is appreciated, however, that implementations of the present disclosure are applicable in other contexts. For example, implementations of the present disclosure may also be used to capture assessments of disruptive entities or non-disruptive entities in other, non-healthcare industries, such as other services, automotive, agriculture, telecommunications, retail, pharmaceutical, banking, consumer goods, manufacturing, utilities, energy, high tech, and governmental agencies. That is, implementations of the present disclosure are flexible enough to be used across a wide variety of industries.

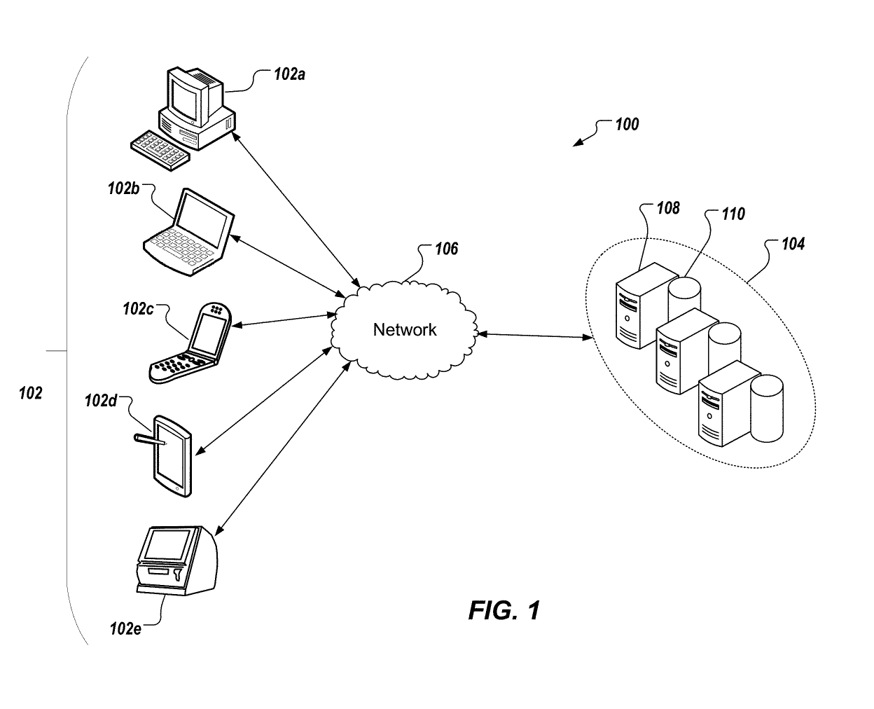

FIG. 1 depicts an example computing system 100 that can execute implementations of the present disclosure. The computing system 100 includes one or more computing devices 102 (e.g., client devices) that communicate with a server system 104 over a network 106. In the example of FIG. 1, the computing devices 102 include a desktop computer 102a, a laptop computer 102b, a mobile smart phone 102c, a tablet computer 102d, and a kiosk computer 102e. In some implementations, any of the computing devices 102 may represent various forms of data processing devices including, but not limited to, a desktop computer, a laptop computer, a tablet computer, a handheld computer, a personal digital assistant (PDA), a cellular telephone, a network appliance, a camera, a smart phone, an enhanced general packet radio service (EGPRS) mobile phone, a media player, a navigation device, an email device, a game console, a kiosk computer, or a combination of any two or more of these data processing devices or other data processing devices. While six computing devices 102 are depicted in FIG. 1, it should be understood that the computing system 100 may include a different number of computing devices 102 in other implementations. The computing devices 102 can interact with application software provided by the server system 104.

Generally, the server system 104 includes one or more computers in one or more physical locations. In some implementations, the server system 104 includes one or more servers 108 and one or more databases 110 (e.g., repository resources). The servers 108 may represent various forms of servers including, but not limited to, a web server, an application server, a proxy server, a network server, or a server farm. For example, the servers 108 may be application servers that execute software accessed by the computing devices 102. In operation, multiple computing devices 102 can communicate with the servers 108 via the network 106. While three servers 108 and three databases 110 are depicted in FIG. 1, it should be understood that the computing system 100 may, in some implementations, include a different number of servers 108 and a different number of databases 110. In some implementations, a user can invoke applications available on the servers 108 through a user-interface application (e.g., a web browser) running on a computing device 102. Each application can individually access data from one or more of the databases 110.

In some implementations, the computing system 100 can be a distributed client/server system that spans one or more networks that may include the network 106. The network 106 can be a large computer network, such as a local area network (LAN), wide area network (WAN), the Internet, a cellular network, or a combination thereof connecting any number of mobile clients, fixed clients, and servers. In some implementations, each computing device 102 can communicate with the server system 104 through a virtual private network (VPN), Secure Shell (SSH) tunnel, or other secure network connection. In some implementations, the network 106 can include the Internet, a wireless service network, and may include the Public Switched Telephone Network (PSTN). In other implementations, the network 106 may include a corporate network (e.g., an intranet) and one or more wireless access points.

Within the non-limiting example context discussed herein, implementations of the present disclosure will be described with respect to an example tool (e.g., one or more software programs executed on a server system) that can capture assessments of disruptive digital health entities to generate an information base including the assessments or to augment the information base by contributing the assessments to the information base. The assessments can be provided by front-end users (e.g., investors and other front-end users) of the tool such that the information base is a crowdsourced knowledge base. The information base can be accessed by decision-makers within the healthcare industry to effect or to inform strategic business decisions based on the assessments within the information base. Such strategic business decisions may be related to venture capital investments, mergers and acquisitions, corporate technology strategies, corporate investments, market entry strategies, and strategic long-term roadmaps.

The disruptive digital health entities may include emerging entities (e.g., entities entering the healthcare industry) that offer innovative digital technology capabilities that can transform ways in which entities deliver and in which consumers of the healthcare industry receive healthcare. The disruptive digital health entities may include start-up companies; new subsidiaries, divisions, or programs within established companies; new organizations; new public (e.g., governmental) or private agencies; and academic-based initiatives. Such start-up companies and established companies may include hospital systems, private healthcare practices, health insurance providers, pharmacy benefits management companies, retail healthcare companies (e.g., retail pharmacies), medical equipment companies, home healthcare facilities, long-term healthcare facilities, and wellness programs. The consumers may include customers within the healthcare industry, such as healthcare patients, health insurance plan members, or pharmacy customers or other individuals associated with the customers (e.g., family members of the customers). The decision-makers within the healthcare industry may include venture capitalists and other investors, executives, board of director members, employees, consultants, and medical professionals (e.g., physicians, nurses, or other clinicians).

In implementations of the present disclosure, the computing devices 102 of the computing system 100 of FIG. 1 can present user interfaces that are generated by the tool and that are configured to receive inputs from users of the tool. The inputs are sent over the network 106 to the server system 104, on which the tool is executed. The server system 104 can store the inputs, generate outputs (e.g., user interfaces including graphical and textual outputs) based on the inputs, and send the outputs over the network 106 to one or more of the computing devices 102. The one or more computing devices 102 can display the outputs to users of the tool.

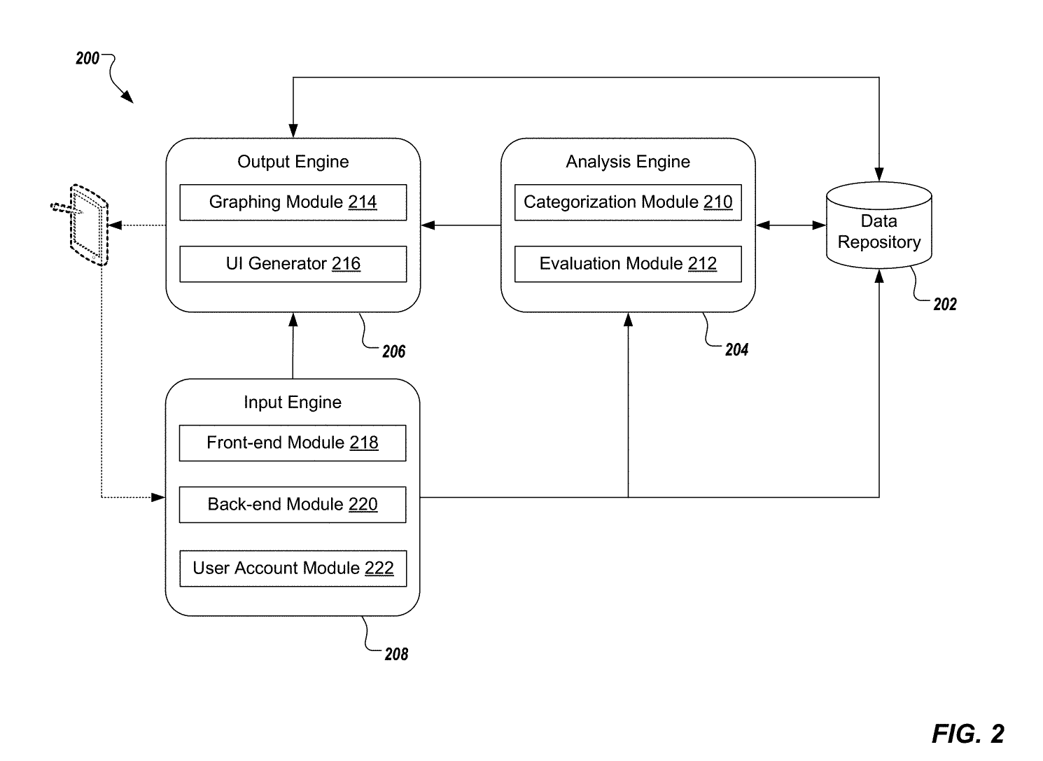

FIG. 2 depicts an example disruption assessment tool 200 (e.g., a digital health disruption rating tool) in accordance with implementations of the present disclosure. In some examples, the disruption assessment tool 200 is a computing environment implemented via the computing system 100. Accordingly, the disruption assessment tool 200 can be provided as a mobile computing application (e.g., outputting front-end user interfaces to mobile computing devices, such as the laptop computer 102b, the mobile smart phone 102c, or the tablet computer 102d of the computing system 100) or as a desktop computing application (e.g., outputting front-end user interfaces to stationary computing devices, such as the desktop computer 102a or the kiosk computer 102e of the computing system 100). The disruption assessment tool 200 can capture assessments of disruptive digital health entities to generate an information base including the assessments or to augment the information base by contributing the assessments to the information base. The assessments can be provided by front-end users (e.g., investors and other front-end users) of the disruption assessment tool 200. In this regard, the information base is a crowdsourced knowledge base that can be accessed by decision-makers within the healthcare industry to effect or to inform strategic business decisions based on the assessments within the information base.

The disruption assessment tool 200 includes a data repository 202 (e.g., implemented on one or more of the databases 110 of the computing system 100), an analysis engine 204 (e.g., implemented on one or more of the servers 108 of the computing system 100), an output engine 206 (e.g., implemented on one or more of the servers 108 of the computing system 100), and an input engine 208 (e.g., implemented on one or more of the servers 108 of the computing system 100). The data repository 202 stores front-end data and back-end data that originate from a variety of sources and that are sent to the disruption assessment tool 200 over a network (e.g., the network 106 of the computing system 100). The data repository 202 also stores additional data that is generated by the disruption assessment tool 200 based on front-end data or back-end data received in the input engine 208. The data repository 202 additionally stores user profile data associated with user accounts of the disruption assessment tool 200.

The back-end data includes data originating from back-end users (e.g., administrators, strategists, and consultants) of the disruption assessment tool 200 or from various electronic sources (e.g., databases, websites, Rich Site Summary (RSS) feeds, and social media streams) accessible to the disruption assessment tool 200. The front-end data includes data originating from front-end users of the disruption assessment tool 200, such as individuals providing assessments of disruptive digital health entities (e.g., investors, healthcare executives, healthcare consultants, healthcare consumers, and healthcare providers, and the general public). In some examples, back-end users of the disruption assessment tool 200 may have front-end access privileges, such that the back-end users can also provide assessments of disruptive digital health entities.

The back-end data stored in the data repository 202 includes an index (e.g., a data structure including a numbered listing) of multiple disruptive digital health entities (e.g., tens, hundreds or thousands of disruptive digital health entities), as well as information (e.g., profile information and financial information) associated with each of the disruptive digital health entities. The back-end data also includes instructions (e.g., categorization schemes, scoring schemes, and analysis schedules) for processing the index of disruptive digital health entities and the information associated with the disruptive digital health entities to generate supplemental data that may be stored in association with the back-end data or further processed. The instructions may be provided as software, that when executed, causes one or more server systems on which the disruption assessment tool 200 is implemented to process the index of disruptive digital health entities and the information associated with the disruptive digital health entities.

In some examples, the instructions are entered into back-end user interfaces generated by the output engine 206 and received in the input engine 208. In some examples, entries (e.g., index entries) of disruptive digital health entities and information associated with the disruptive digital health entities are entered into back-end user interfaces generated by the output engine 206 and received in the input engine 208. In some examples, entries of disruptive digital health entities and information associated with the disruptive digital health entities are retrieved by the input engine 208 from one or more electronic sources (e.g., websites affiliated with the disruptive digital health entities or databases storing information related to the disruptive digital health entities) in communication with the disruption assessment tool 200. In some implementations, entries of disruptive digital health entities and information associated with the disruptive digital health entities are retrieved from the one or more electronic sources on a periodic schedule (e.g., daily, weekly, monthly, quarterly, or yearly) that is set by a back-end user of the disruption assessment tool 200. The periodic schedule may be included in an instruction entered into a back-end user interface. In some examples, entries of disruptive digital health entities and information associated with the disruptive digital health entities are retrieved from one or more electronic sources on-demand (e.g., upon request of a back-end user of the disruption assessment tool 200).

In some examples, information associated with disruptive digital health entities includes profile information. For each disruptive digital health entity, profile information may include one or more of a summary providing a high-level description of services and/or products offered by a disruptive digital health entity, a brief history of the disruptive digital health entity, a uniform resource locator (URL) of a website of the disruptive digital health entity, a geographical location (e.g., one or more of a city, a state, a country, and a continent) of the disruptive digital health entity, a mission statement of the disruptive digital health entity, a number of competitors of the disruptive digital health entity, a number of awards received by the disruptive digital health entity, a number of incubators to which the disruptive digital health entity belongs, types of innovation provided by the disruptive digital health entity (e.g., as will be discussed with respect to Table 1), a number of employees, a number of business partners, a size of the industry to which the disruptive digital health entity belongs, and a size of an industry being displaced by the disruptive digital health entity.

In some examples, information associated with disruptive digital health entities includes financial information. For each disruptive digital health entity, financial information may include one or more of a funding amount received per year over a predetermined number of years, a total funding amount received since inception, a category of a funding amount (e.g., less than $1 Million, $1 Million-$20 Million, or greater than $20 Million), a round of venture capital funding, revenues generated, a date of a most recent funding, real estate costs, equipment and other capital costs, overhead rates, profit margins, and returns on investments for various business initiatives. In some examples, a sufficiently past date of most recent funding may indicate that a disruptive digital health entity is no longer funded.

In some implementations, the instructions for processing the index of disruptive digital health entities and the information associated with the disruptive digital health entities include a categorization scheme for categorizing the disruptive digital health entities. For example, the instructions, when executed, cause one or more server systems on which the disruption assessment tool 200 is implemented to carry out the categorization scheme. The categorization scheme includes multiple sectors (e.g., primary categories) that can be associated with the disruptive digital health entities, multiple tags (e.g., secondary categories) that can be associated with the disruptive digital health entities, and sets of keywords associated with one or both of each sector and each tag. The sectors are themes that reflect high-level aspects of healthcare. The sectors may include but are not limited to Consumer Engagement, Treatment, Diagnosis, and Infrastructure and Payment. The tags are classifications or labels that reflect lower-level (e.g. specific or detailed) aspects of healthcare. Example tags and associated descriptions are provided in Table 1 below.

TABLE 1
Sectors and Tags

| Sector | Tag | Description |
|---|---|---|
| Consumer | Nutrition | Enables a healthy diet |
| Engagement | Wearable Devices | Engages consumers in their health and wellness with mobile hardware |
| | Access | Simplifies the process of finding and using hospital or physician |
| | | services or receiving medication |
| | Transparency | Enables smarter health decision making and maximizes value/price |
| | Interoperability | Connects disparate health devices and applications |
| | Incentives and Social | Rewards healthy behavioral change and sharing progress |
| | Networks | |
| | Gamification | Creates a game-like atmosphere to promote healthy behaviors |
| Diagnosis | Enhanced Provider | Improves providers' ability to diagnose effectively |
| | Diagnosis | |
| | Self Diagnosis | Empowers consumers to determine when they should seek care |
| | Remote Monitoring | Uses sensors to track health status and share with caregivers |
| Treatment | Self Care | Provides a patient with the ability to treat themselves |
| | Virtual Care and | Delivers or coordinates health services and/or counseling remotely |
| | Coordination | |
| | Physician Efficiency | Improves the provider experience and patient outcomes |
| | Personalized Medicine | Tailors treatment to the individual, with a focus on genetics |
| | Medication | Reminds patients to remain adherent to their prescription plan |
| | Management | |
| Infrastructure | Payment Methods | Simplifies payment for health services |
| and Payment | Big Data and | Powers provider and public health decision making in aggregate |
| | Population Analytics | |
| | Back Office | Drives efficient payer/provider operations |
| | Administration | |
| | Clinical Trials | Supports the development of next generation therapeutics |
| | Crowd Funding | Helps health innovators access capital |

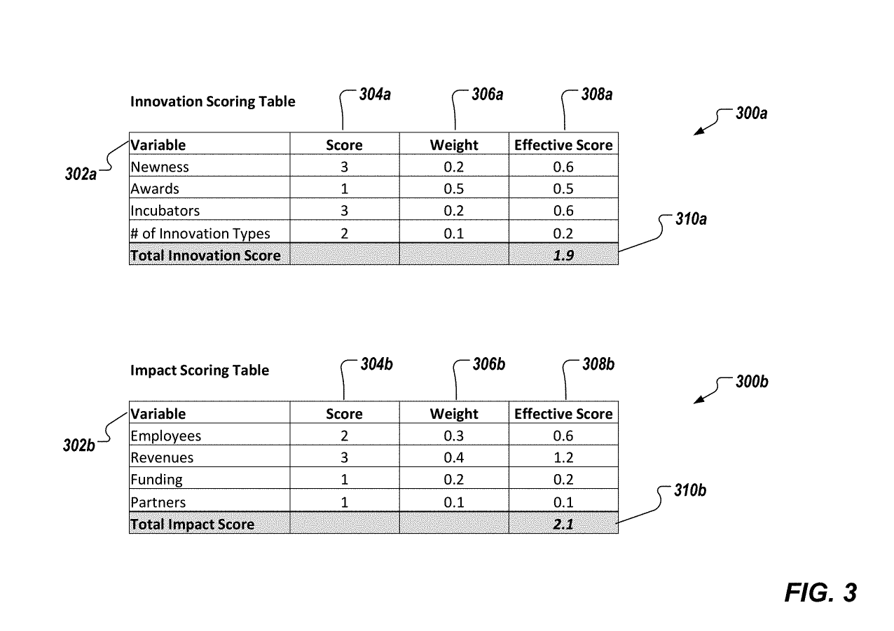

In some implementations, the instructions for processing the index of disruptive digital health entities and the information associated with the disruptive digital health entities include a scoring scheme for scoring the disruptive digital health entities. For example, the instructions, when executed, cause one or more server systems on which the disruption assessment tool 200 is implemented to carry out the scoring scheme. Scores can include innovation scores reflecting a level of innovativeness of a disruptive digital health entity and impact scores reflecting a level of impact experienced by one or both of the healthcare industry and healthcare consumers as a result of the disruptive digital health entity entering the healthcare industry. In an example scoring scheme, scores are selectable from a set of integers that correspond to defined ranges of multiple innovation variables and impact variables. Weights can be applied to the variables to generate a total innovation score and a total impact score, as will be discussed in more detail below with respect to FIG. 3. Example innovation variables include a number of competitors of a disruptive digital health entity, a number of awards received by the disruptive digital health entity, a number of incubators to which the disruptive digital health entity belongs, a number of the types of innovation provided by the disruptive digital health entity, a uniqueness of services and/or products offered by the disruptive digital health entity, and a measure of growth of the disruptive digital health entity as compared to growth of one or more. Example impact variables include a number of employees, a generated revenue, a total funding amount received, a number of business partners, and a size of an industry displaced.

Accordingly, additional data stored in the data repository 202 includes categorizations and scores of the disruptive digital health entities. The categorizations and scores may generated by the analysis engine 204, as will be discussed in more detail below.

The front-end data stored in the data repository 202 includes ratings of disruptive digital health entities and other assessments of the disruptive digital health entities. The assessments can include special designations (e.g., ‘Favorite’ or ‘Star’ designations) of the disruptive digital health entities, requests for improved profiles of the disruptive digital health entities, and comments about disruptive digital health entities. In some examples, the ratings and other assessments are entered into front-end user interfaces generated by the output engine 206 and received in the input engine 208. In some examples, front-end data is entered at a time or at multiple times according to a frequency that may be selected by of a front-end user of the disruption assessment tool 200. For example, a front-end user may decide to access the disruption assessment tool 200 and provide front-end data at any time. In some examples, front-end data is provided at a time or at multiple times according to a frequency that may be selected by of a back-end user of the disruption assessment tool 200. For example, front-end data may be provided by a front-end user upon receipt of a notification (e.g., an email, a text message, or an alert) requesting entry of front-end data (e.g., upon being prompted by the disruption assessment tool 200).

User profile data stored in the data repository 202 can include several parameters associated with user accounts of the disruption assessment tool 200. The parameters can include a user ID (e.g., a user login), an administrative status (e.g., an administrator or a non-administrator), a user type (e.g., a super user, a power user, a standard user, etc.), a time and date that a user last accessed the system, a total number of times that a user has logged into the system, a total number of ratings (or other assessments) received by a user, a total number of positive ratings received by a user, a total number of negative ratings received by a user, a number of special designations received by a user, a geographic location of a user, a job title of a user, an employer of the user, an industry in which a user is employed, and a competitor of an employer of a user.

The analysis engine 204 includes a categorization module 210 and an evaluation module 212. The analysis engine 204 receives back-end data (e.g., an index of disruptive digital health entities and information associated with the disruptive digital health entities) from the input engine 208, receives back-end data (e.g., a categorization scheme, a scoring scheme, and an analysis schedule for processing the index and the information) from the data repository 202, and processes the back-end data to generate supplemental data (e.g., categorizations of each disruptive digital health entity, scores for each disruptive digital health entity, and aggregate statistics reflecting multiple disruptive digital health entities). In some examples, the categorization module 210 assigns one or more sectors and one or more tags to each disruptive digital health entity based on keywords associated with sectors and tags within the categorization scheme. In instances in which a disruptive digital health entity is associated with multiple sectors, the disruptive digital health entity may be associated with a primary sector, a secondary sector, a tertiary sector, etc. In instances in which a disruptive digital health entity is associated with multiple tags, the disruptive digital health entity may be associated with a primary tag, a secondary tag, a tertiary tag, etc. In some examples, the categorization module 212 identifies keywords displayed on a web site affiliated with a disruptive digital health entity or within other information associated with the disruptive digital health entity. The analysis engine 204 sends the index of disruptive digital health entities, the information associated with the disruptive digital health entities, sector assignments, and tag assignments to the data repository 202 for storage. In other examples, the sector assignments and tag assignments may be provided by a back-end user of the disruption assessment tool, as will be discussed in more detail below.

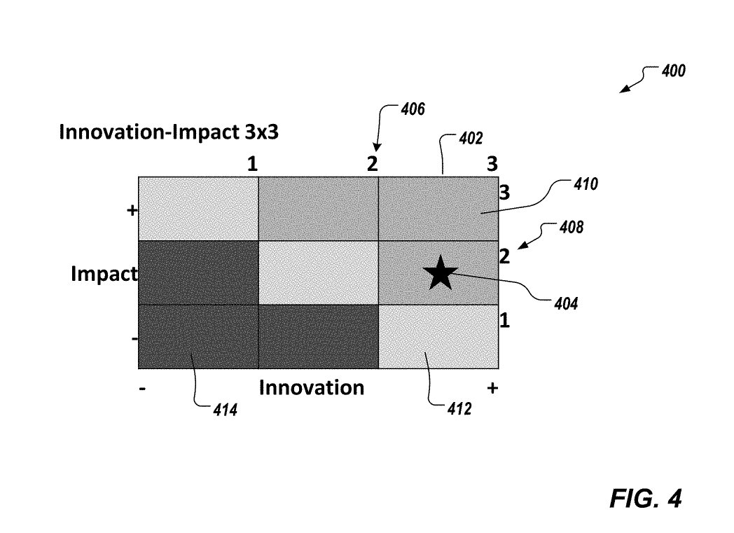

In some implementations, the evaluation module 212 generates multiple innovation scores and multiple impact scores for each disruptive digital health entity based on the scoring scheme. The evaluation module 212 can calculate a total innovation score and a total impact score for each disruptive digital health entity based on the multiple innovation scores and the multiple impact scores. The evaluation module 212 generates data structures (e.g., scoring tables) that store the innovation scores and the impact scores for each disruptive digital health entity, as will be discussed in more detail below with respect to FIG. 3. In some examples, the evaluation module 212 generates a composite score reflecting the multiple innovation scores and the multiple impact scores. In some implementations, the evaluation module 212 can generate a ranking of the disruptive digital health entities indexed within the data repository 202 based on the total innovation scores, the total impact scores, or the composite scores. In some examples, the analysis engine 204 sends one or both of the rankings and the data structures including the scores to the data repository 202 for storage. In some examples, a ranking can be displayed in user interface generated by the output engine 206 to provide additional insight into a standing of a digital health disruptor. In some examples, the analysis engine 204 sends the data structures including the scores to the output engine 206 for further processing, as will be discussed in more detail below with respect to FIG. 4.

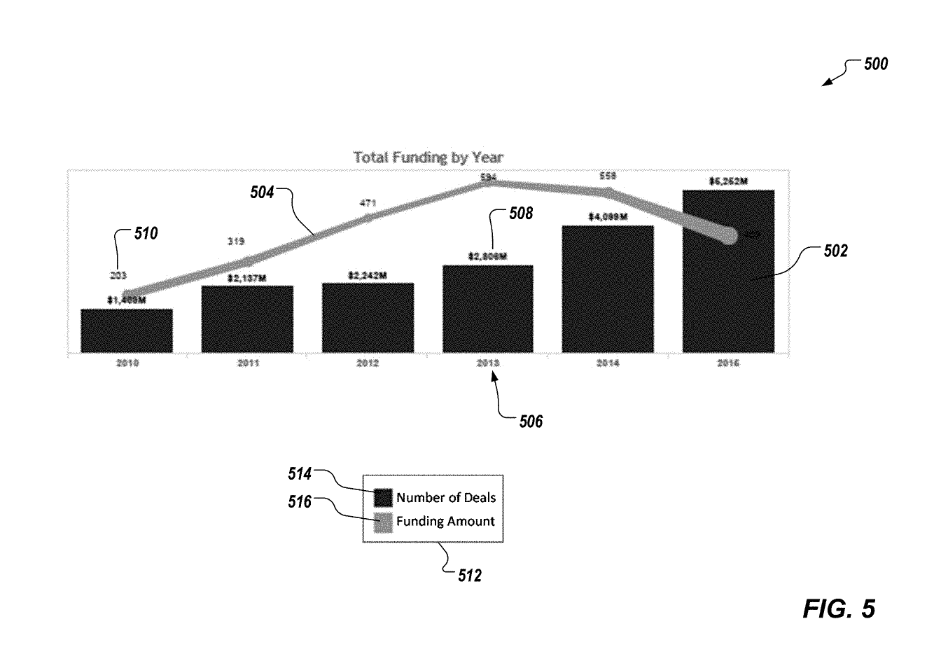

In some implementations, the evaluation module 212 performs calculations across multiple disruptive digital health entities to generate aggregate statistics with respect to themes, tags, time periods, funding amounts, geographical locations, funding rounds, various medical specialties, and various medical conditions (e.g., diabetes). The evaluation module 212 generates data structures that store the aggregate statistics. In some examples, the analysis engine 204 sends the data structures including the aggregate statistics to the data repository 202 for storage. In some examples, the analysis engine 204 sends the data structures including the aggregate statistics to the output engine 206 for further processing, as will be discussed in more detail below with respect to FIGS. 5-8.

The output engine 206 includes a graphing module 214 and a user interface (UI) generator 216. The output engine 206 receives supplemental data (e.g., scores and aggregate statistics) from the analysis engine 204; instructions from the input engine 208; and back-end data (e.g., profile information associated with disruptive digital health entities), front-end data (e.g., ratings of disruptive digital health entities), and user profile data from the data repository 202. The graphing module 214 can plot the scores and the aggregate statistics in a variety of coordinate systems to generate multiple different graphical outputs, including bar graphs, line graphs, charts, information maps, graphical matrices, and other types of graphs, as will be discussed in more detail below with respect to FIGS. 4-8. In some examples, the output engine 206 sends the graphical outputs to the data repository 202 for storage. In some examples, the graphing module 214 sends the graphical outputs to the UI generator 216 for integration into various user interfaces that can be outputted to one or more computing devices. That is, the output engine 206 can provide the graphical outputs for presentation in a user interface being presented on a display of a processing device (e.g., for presentation in a web browser or a special-purpose application executing on the processing device and configured to interact with the disruption assessment tool 200 over a network). In some examples, the output engine 206 provides a subset of the generated graphical outputs to the processing device based on a user selection of desired graphical outputs. In some examples, the output engine 206 provides all of the generated graphical outputs to the processing device.

The UI generator 216 can generate various front-end user interfaces, back-end user interfaces, and account user interfaces that are sent from the output engine 206 to one or more computing devices. The account user interfaces include account registration interfaces for creating login IDs and passwords, inputting personal information, and reviewing privacy notices. The account user interfaces also include login interfaces for accessing the disruption assessment tool 200 and password reset interfaces for resetting passwords. In some examples, a back-end user account can have front-end access privileges, and login interfaces can include a selector for choosing a type of access with which to navigate the disruption assessment tool 200.

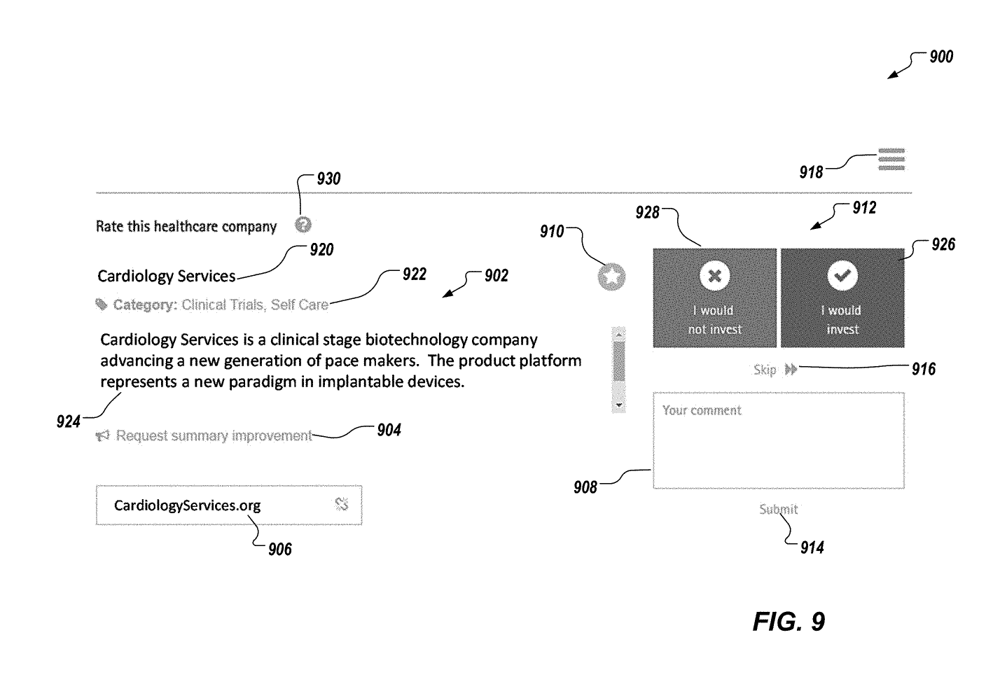

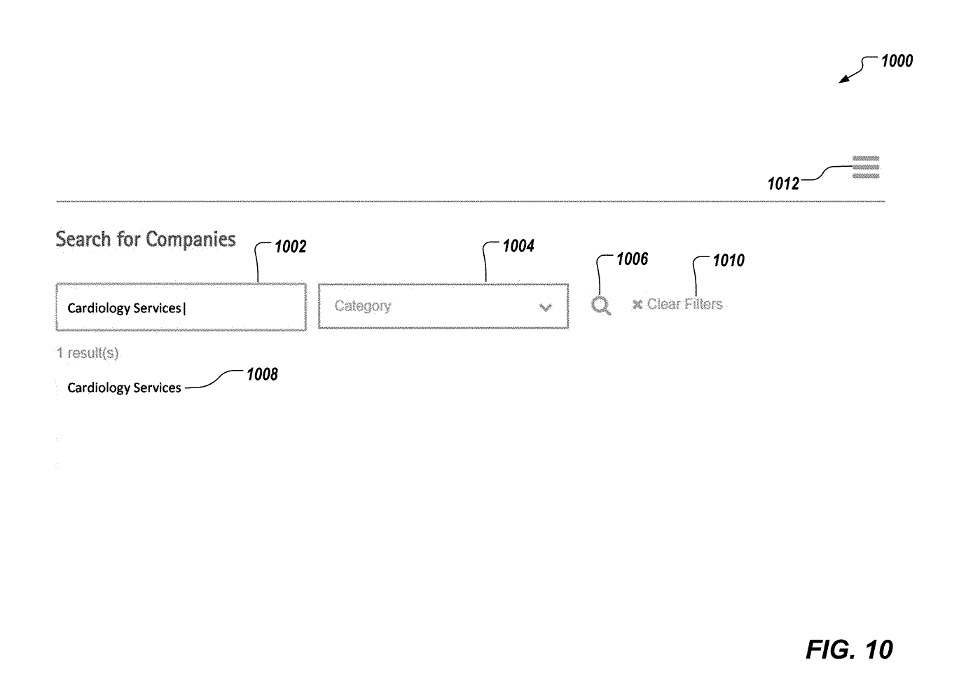

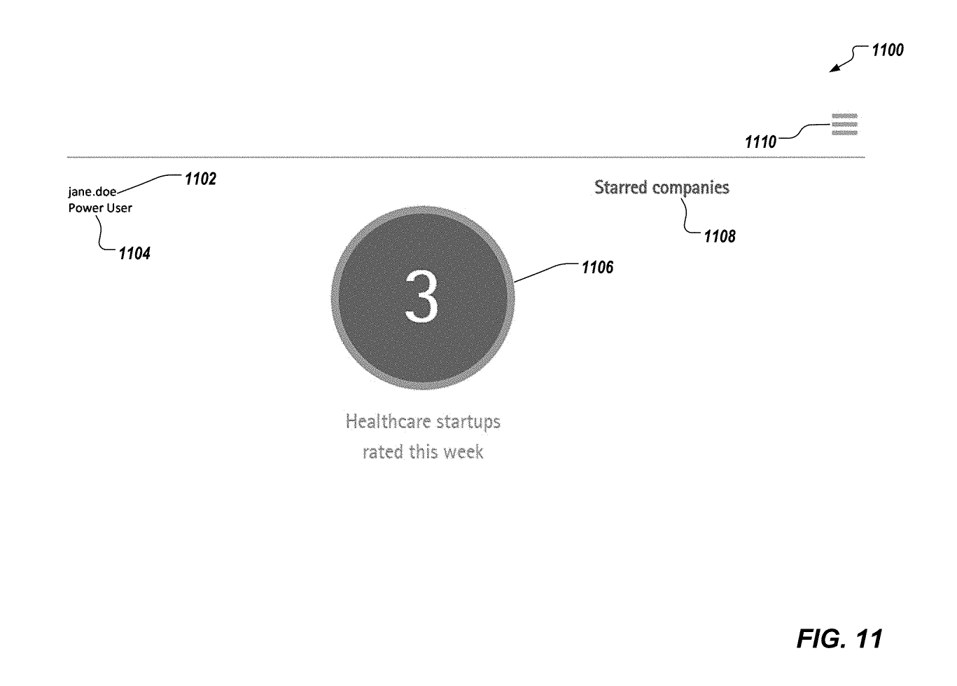

The front-end user interfaces include assessment interfaces for rating disruptive digital health entities, providing comments about disruptive digital health entities, and requesting improved profiles of disruptive digital health entities, as will be discussed in more detail with respect to FIG. 9. The front-end user interfaces also include search interfaces for searching disruptive digital health entities, as will be discussed in more detail with respect to FIG. 10. The front-end user interfaces can additionally include summary displays providing user profile data or aggregate analyses of disruptive digital health entities, as will be discussed in more detail with respect to FIGS. 9 and 11.

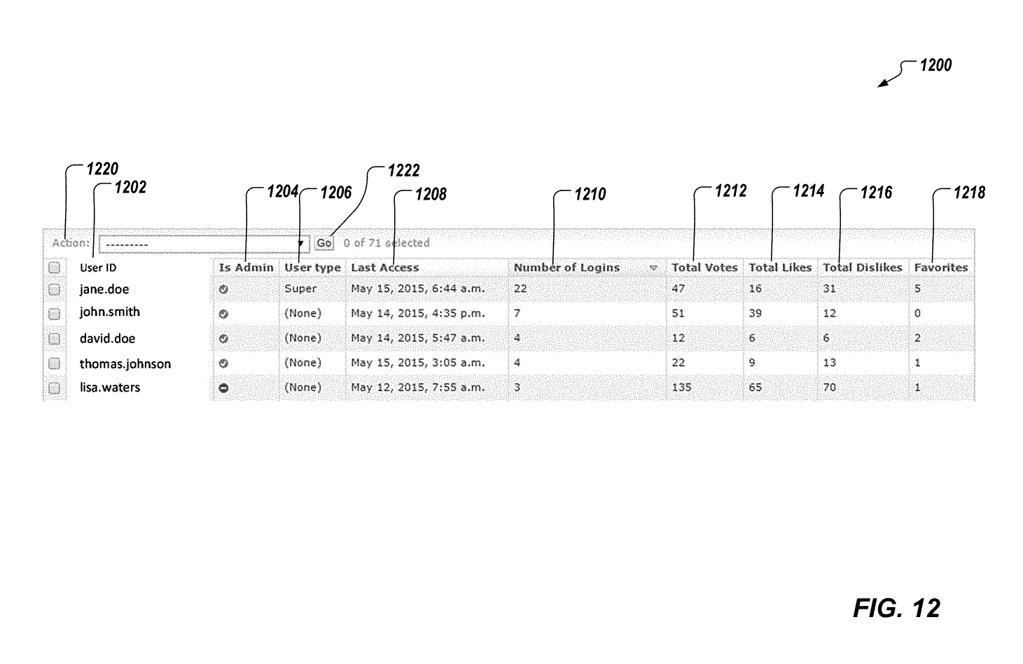

The back-end user interfaces include parameter interfaces for providing instructions (e.g., categorization schemes, scoring schemes, and analysis schedules) for processing an index of disruptive digital health entities and information associated with the disruptive digital health entities. The back-end user interfaces also include administrative interfaces for individual and aggregate user profile data, supplemental data generated by the analysis engine 204, and assessments of disruptive digital health entities, as will be discussed in more detail with respect to FIGS. 12-14.

The input engine 208 includes a front-end module 218, a back-end module 220, and a user account module 222. The input engine 208 receives front-end data, back-end data, and user profile data entered into front-end user interfaces, back-end user interfaces, and account access user interfaces generated by the UI generator 216. For example, the user account module 222 can receive user profile data entered into an account interface generated by the UI generator 216. In some examples, the user account module 222 creates a new user account based on new user profile data entered into an account user interface and sends the new user profile data to the data repository 202 for storage. In some examples, the user account module 222 accesses user profile data stored in the data repository 202 to verify the user profile data entered into the account interface and to determine whether the user profile data is associated with a front-end user account or a back-end user account. According to a result of the verification (e.g., valid account access information or invalid account access information), the input engine 208 generates and sends an instruction to the output engine 206 to generate and output a subsequent user interface (e.g., a front-end user interface, a back-end user interface, or an additional account access user interface). For example, the instruction, when executed, can cause one or more server systems on which the disruption assessment tool 200 is implemented to generate and output a subsequent user interface.

The front-end module 218 can receive front-end data, such as ratings of disruptive digital health entities, special designations of disruptive digital health entities, comments about disruptive digital health entities, requests for improved profiles of disruptive digital health entities, search requests (e.g., based on one or both of keywords and filters) for disruptive digital health entities, and requests for financial information related to one or more disruptive digital health entities. In some examples, the front-end module 218 sends the front-end data (e.g., ratings, special designations, comments, and requests for improved profiles) to the data repository 202 for storage in association with back-end data (e.g., the index of disruptive digital health entities). In some examples, the front-end module 218 generates an instruction for generating and outputting a subsequent front-end user interface based on the front-end data. For example, the instruction, when executed, can cause one or more server systems on which the disruption assessment tool 200 is implemented to generate and output a subsequent front-end user interface. The front-end module 218 sends the instruction to the output engine 206.

The back-end module 220 can receive back-end data, such as instructions (e.g., categorization schemes, scoring schemes, and analysis schedules) for processing an index of disruptive digital health entities; instructions for processing information associated with the disruptive digital health entities; and requests for viewing analyses of user profile data, supplemental data generated by the analysis engine 204, and rating data of disruptive digital health entities. In some examples, the back-end module 220 sends the back-end data (e.g., instructions for processing an index of disruptive digital health entities and information associated with the disruptive digital health entities) to the data repository 202 for storage. In some examples, the back-end module 220 generates an instruction for generating and outputting a subsequent back-end user interface based on the back-end data (e.g., requests for viewing analyses of user profile data, supplemental data generated by the analysis engine 204, and rating data of disruptive digital health entities) and sends the instruction to the output engine 206. In some examples, the back-end module 218 receives categorizations (e.g., sector assignments and tag assignments) of disruptive digital health entities from a back-end user of the disruption assessment tool 200 and sends the categorizations to the data repository 202 for storage in association with the index of disruptive digital health entities.

FIG. 3 depicts example scoring tables 300a, 300b in accordance with implementations of the present disclosure. The scoring tables 300a, 300b are data structures that are generated by the evaluation module 208 of the analysis engine 204 based on back-end data (e.g., profile information related to disruptive digital health entities) received from the input engine 208 or from the data repository 202.

The innovation scoring table 300a includes innovation variables 302a, innovation scores 304a, and innovation weights 306a. In an example scoring scheme, the innovation scores 304a are provided as integer numbers including 1 through 3 for each innovation variable. For the innovation variable 302a of Newness, the numbers 1, 2, and 3 correspond to 7+ direct competitors, 3-6 direct competitors, and 0-2 direct competitors, respectively. For the innovation variable 302a of Awards, the numbers 1, 2, and 3 correspond to 0 awards, 1-3 awards, and 4+ awards, respectively. For the innovation variable 302a of Incubators, the numbers 1, 2, and 3 correspond to 0 incubators, 1-3 incubators, and 4+ incubators, respectively. For the innovation variable 302a of Number of Innovation Types, the numbers 1, 2, and 3 correspond to 1-3 types, 4-6 types, and 7+ types, respectively. The innovation weights 306a include fractions that total 1.0. The innovation scoring table 300a includes effective innovation scores 308a that are calculated as a multiplication of the innovation score 302a and a respective innovation weight 304a. The innovation scoring table 300a also includes a total innovation score 310a that is calculated as a sum of the effective innovation scores 308a. In the example scoring scheme, a maximum total innovation score of 3.0 is achievable.

The impact scoring table 300b includes impact variables 302b, impact scores 304b, and impact weights 306b. In an example scoring scheme, the impact scores 304b are provided as integer numbers including 1 through 3 for each impact variable. For the impact variable 302b of Employees, the numbers 1, 2, and 3 correspond to 1-10 employees, 11-50 employees, and 51+ employees, respectively. For the impact variable 302b of Revenues, the numbers 1, 2, and 3 correspond to $0≧revenues≧$5M, $5≧revenues≧$10M, and revenues>$10M, respectively. For the impact variable 302b of Funding, the numbers 1, 2, and 3 correspond to $0≧funding≧$1M, $1≧funding≧$5M, and funding>$5M, respectively. For the impact variable 302b of Partners, the numbers 1, 2, and 3 correspond to 0-2 partners, 3-9 partners, and 10+ partners, respectively. The impact weights 306b include fractions that total 1.0. The impact scoring table 300b includes effective impact scores 308b that are calculated as a multiplication of an impact score 302a and a respective impact weight 304b. The impact scoring table 300b also includes a total impact score 310b that is calculated as a sum of the effective impact scores 308b. In the example scoring scheme, a maximum total impact score of 3.0 is achievable.

In some implementations, the evaluation module 212 of the analysis engine 204 can generate a composite score that reflects two or more different scores. For example, the composite score can reflect both the total innovation score 310a and the total impact score 310b. In some examples, the composite score is in the form of a coordinate number, such as (total innovation score, total impact score). In the example of FIG. 3, the composite score may be (1.9, 2.1). In some examples, the composite score is generated according to a different scheme. In some examples, the analysis engine 204 sends one or both of the scoring tables 300a, 300b and the composite score to the data repository 202 for storage. In some examples, the analysis engine 204 sends the scoring tables 300a, 300b to the output engine 206 for further processing.

FIG. 4 depicts an example scoring matrix 400 in accordance with implementations of the present disclosure. The scoring matrix 400 provides an innovation-impact matrix that is generated by the graphing module 214 of the output engine 206. The scoring matrix 400 provides an easy-to-understand summary snapshot of an overall innovation-impact state of a disruptive digital health entity. The scoring matrix 400 includes multiple cells 402 (e.g., 9 cells providing a 3×3 matrix) in which an indicator 404 (e.g., a symbol, an icon, a name, or another representation) can be located (e.g., plotted) according to the total innovation score 310a and the total impact score 310b of the disruptive digital health entity (e.g., 1.9 and 2.1, respectively, in the example of FIG. 4).

The scoring matrix 400 includes an innovation integer range scale 406 defining innovation score ranges (e.g., buckets) of 0≧score≧1, 1>score≧2, and 2>score≧3. The scoring matrix 400 includes an impact integer range scale 408 defining impact score ranges (e.g., buckets) of 0≧score≧1, 1>score≧2, and 2>score≧3. Cells 402 located in a lower left corner of the scoring matrix 400 and shown in a first color 410 (e.g., red) or shading reflect a relatively low innovation-impact state. Cells 402 located along a backwards diagonal of the scoring matrix 400 and shown in second color 412 (e.g., yellow) or shading reflect an average or basic innovation-impact state. Cells 402 located in an upper right corner of the scoring matrix 400 and shown in a third color 414 (e.g., green) or shading reflect a relatively high innovation-impact state. In the example of FIG. 4, the disruptive digital health entity under consideration has a relatively high innovation-impact state, as exhibited by a location of the indicator 404. In some examples, the scoring matrix 400 can display multiple indicators 404 corresponding to multiple disruptive digital health entities. In some examples, the output engine 206 sends the scoring matrix 400 to the data repository 202 for storage. In some examples, the graphing module 214 sends the scoring matrix 400 to the UI generator 216 for incorporation into a user interface.

FIG. 5 depicts an example bar-line graph 500 in accordance with implementations of the present disclosure. The bar-line graph 500 is generated by the graphing module 214 of the output engine 206 and summarizes funding amounts and numbers of deals executed according to year for multiple disruptive digital health entities across multiple tags. The bar-line graph 500 includes a bar series 502, a line plot 504, a scale 506 (e.g., a time scale), bar labels 508, line labels 510, and a legend 512. The bar series 502 and the bar labels 508 represent total amounts of funding received across the multiple disruptive digital health entities. The line plot 504 and the line labels 510 represent total numbers of deals executed across the multiple disruptive digital health entities. In the example of FIG. 5, the legend 512 indicates that a light color 514 corresponds to funding amounts and that a dark color 516 corresponds to deals. In the example of FIG. 5, a total amount of funding increases year after year, while a total number of deals peaks during the year of 2013. In some examples, the output engine 206 sends the bar-line graph 500 to the data repository 202 for storage. In some examples, the graphing module 214 sends the bar-line graph 500 to the UI generator 216 for incorporation into a user interface.

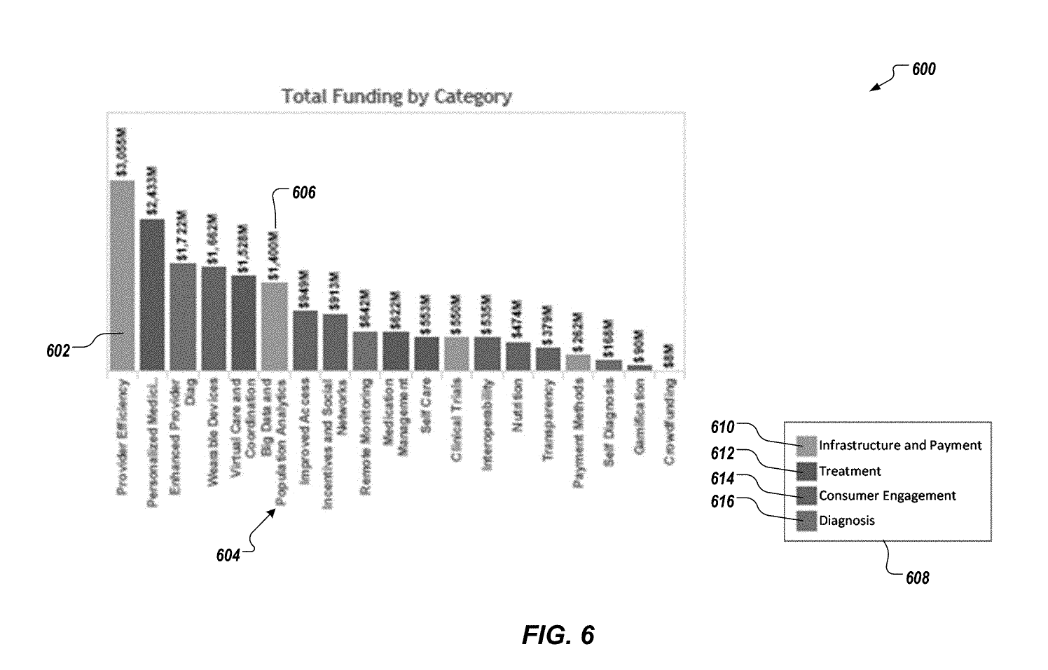

FIG. 6 depicts an example bar graph 600 in accordance with implementations of the present disclosure. The bar graph 600 is generated by the graphing module 214 of the output engine 206 and summarizes funding amounts received over a predetermined period of time (e.g., over a period of years or since inception) according to tags for multiple disruptive digital health entities. The bar graph 600 includes bars 602, a scale 604 (e.g., a categorical scale), bar labels 606, and a legend 608. The bars 502 and the bar labels 506 represent total amounts of funding received across the multiple disruptive digital health entities according to tags. In the example of FIG. 6, the legend 608 indicates that four different colors 610, 612, 614, 616 correspond to the sectors of Infrastructure and Payment, Treatment, Consumer Engagement, and Diagnosis, respectively. In the example of FIG. 6, disruptive digital health entities providing innovation in the category of Provider Efficiency received the highest amount of funding, and disruptive digital health entities providing innovation in the category of Crowdfunding received the lowest amount of funding. In some examples, the output engine 206 sends the bar graph 600 to the data repository 202 for storage. In some examples, the graphing module 214 sends the bar graph 600 to the UI generator 216 for incorporation into a user interface.

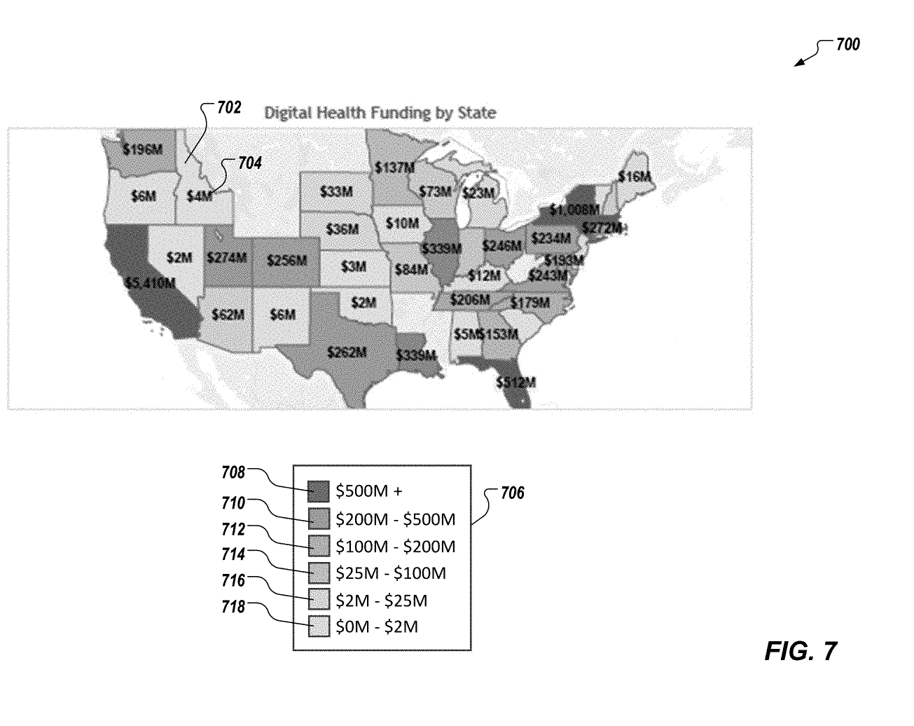

FIG. 7 depicts an example information map 700 in accordance with implementations of the present disclosure. The information map 700 is generated by the graphing module 214 of the output engine 206 and summarizes funding amounts according to geographic locations (e.g., states) over a predetermined period of time (e.g., over a period of years or since inception). The information map 700 includes geographic regions 702 (e.g., states), map labels 704, and a legend 706. The map labels 704 represent total amounts of funding received across the multiple disruptive digital health entities according to a geographic region 702. In the example of FIG. 7, the legend 706 indicates that six different colors 708, 710, 712, 714, 716, 718 or shadings correspond to different ranges (e.g., buckets) of funding. In the example of FIG. 7, disruptive digital health entities affiliated with (e.g., according to a location of a headquarters or other operational site) the state of California received a highest amount of funding, while disruptive digital health entities affiliated with the states of Arkansas, Mississippi, Montana, Wyoming, and North Dakota received a lowest amount ($0) of funding. In some examples, the output engine 206 sends the information map 700 to the data repository 202 for storage. In some examples, the graphing module 214 sends the information map 700 to the UI generator 216 for incorporation into a user interface.

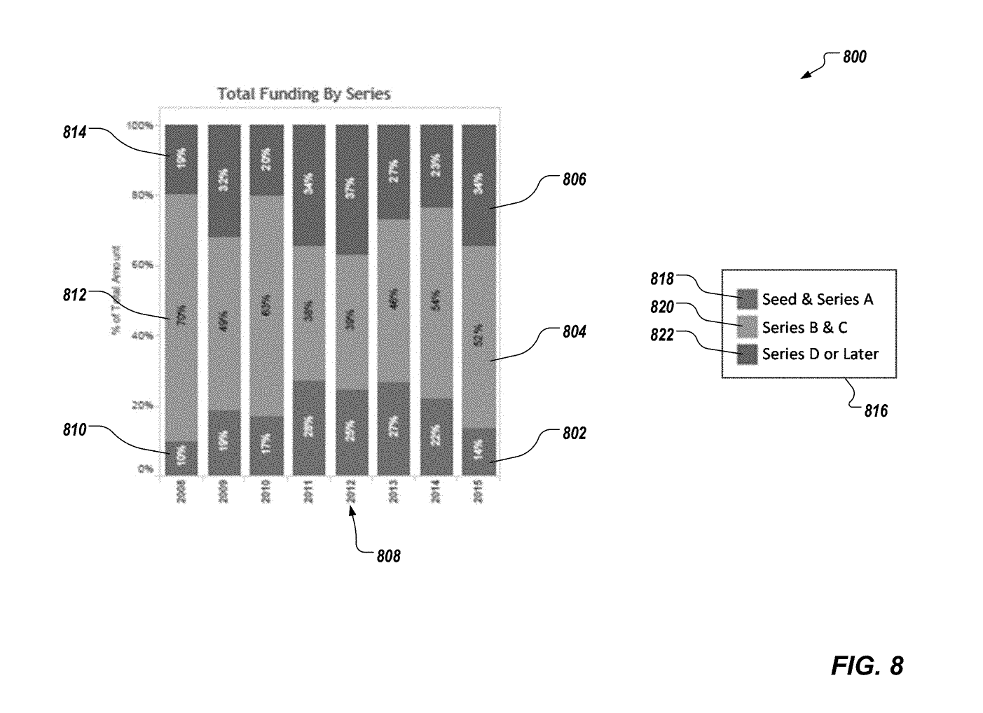

FIG. 8 depicts an example bar graph 800 in accordance with implementations of the present disclosure. The bar graph 800 is generated by the graphing module 214 of the output engine 206 and summarizes funding amounts received over a predetermined period of time (e.g., over a period of years or since inception) according to a round of venture capital funding for multiple disruptive digital health entities. The bar graph 800 includes a first bar series 802, a second bar series 804, a third bar series 806, a scale 808 (e.g., a time scale), a first set of bar labels 810, a second set of bar labels 812, a third set of bar labels 814, and a legend 816. In the example of FIG. 8, the legend 816 indicates that three different colors 818, 820, 822 correspond to the first bar series 802 (Seed & Series A), the second bar series 804 (Series B & C), and the third bar series 806 (Series D or later), respectively. In the example of FIG. 8, disruptive digital health entities overall received a highest amount of funding in the rounds of Series B & C and a lowest amount of funding in the Seed and Series A rounds. In some examples, the output engine 206 sends the bar graph 800 to the data repository 202 for storage. In some examples, the graphing module 214 sends the bar graph 800 to the UI generator 216 for incorporation into a user interface.

FIG. 9 depicts an example front-end user interface 900 in accordance with implementations of the present disclosure. The front-end user interface 900 is generated by the UI generator 216 of the output engine 206 and can be presented on a processing device (e.g., a monitor, a screen, or another display device) of a mobile computing device or a stationary computing device. The front-end user interface 900 is an assessment interface that allows a front end user to provide assessments of a disruptive digital health entity. The front-end user interface 900 includes a profile 902 of a disruptive digital health entity, a request button 904, a URL 906 associated with a website of the disruptive digital health entity, a comment window 908, a special designation button 910, a rating selector 912, a Submit button 914, a Skip button 916, a help button 930 that allows a user to easily access a help function for using the disruption assessment tool 200, and a navigation bar 918 that allows the user to navigate between various user interfaces.

The profile 902 includes back-end data retrieved from the data repository 202. For example, the profile 902 includes a name 920 of the disruptive digital health entity, tags 922 assigned to the disruptive digital health entity, and a summary 924 of services and/or products offered by the disruptive digital health entity. In some examples, the profile 902 can include a ranking of the disruptive digital health entity that has been generated by the evaluation module 212. Based on one or both of a review of the profile 902 and a viewing of the website referenced by the URL 906, a front-end user can provide one or more assessments of the disruptive digital health entity. For example, the front-end user can enter comments into the comment window 908 and submit the comments using the Submit button 914. The front-end user can use a positive rating button 926 or a negative rating button 928 of the rating selector 912 to submit a positive rating or negative rating of the disruptive digital health entity. In this regard, the rating selector 912 is a binary rating selector (e.g., providing two options) for assessing the disruptive digital health entity. Example binary ratings for the rating selector 912 include ‘Hot-or-Not,’ ‘I Would Invest or I Would Not Invest,’ ‘Innovative or Not Innovative,’ ‘ Like or Dislike,’ or ‘Interested or Not Interested.’ In some implementations, the rating selector 912 can include more than two (e.g., n) rating options such that rating selector 912 is an n-ary rating tool. For example, the rating selector 912 may additionally include a neutral rating, an undecided rating, or a no decision rating (e.g., not informed enough to make a decision). In some examples, the front-end user can submit a special designation (e.g., a ‘Favorite’ or a ‘Star’ designation) for the disruptive digital health entity using the special designation button 910. In some examples, the front-end user can use the request button 904 to request an improved summary 920 for the disruptive digital health entity. In some examples, the front-end user can use the Skip button 904 to skip to a next disruptive digital health entity.

In some examples, the profile 902 alternatively or additionally includes other profile information associated with the disruptive digital health entity (e.g., or a link to such profile information), such as one or more of a brief history of the disruptive digital health entity, a geographic location of the disruptive digital health entity, a mission statement of the disruptive digital health entity, a number of competitors of the disruptive digital health entity, a number of awards received by the disruptive digital health entity, a number of incubators to which the disruptive digital health entity belongs, types of innovation provided by the disruptive digital health entity, a number of employees, a number of business partners, a size of the industry to which the disruptive digital health entity belongs, and a size of an industry being displaced by the disruptive digital health entity.

In some examples, the profile 902 alternatively or additionally includes other graphical displays (e.g., or links to other graphical displays) associated with the disruptive digital health entity or associated with multiple disruptive digital health entities indexed within the data repository. For example, the other graphical displays can include a scoring matrix 400, a bar-line graph 500, a bar graph 600, an information map 700, a bar graph 800, or other types of graphs generated by the output engine 206.

Front-end data including assessments (e.g., ratings, special designations, requests, and comments) entered into the front-end user interface 900 is received in the front-end module 218 of the input engine 208. The assessments collectively form an information base (e.g., a reference base or a knowledge base). The input engine 208 sends the front-end data to the data repository 202 for storage in association with the disruptive digital health entity and in association with a front-end user account. Based on the front-end data, the front-end module 218 also generates an instruction, and the input engine 208 sends the instruction to the output engine 206. According to the instruction, the UI generator 216 of the output engine generates a next user interface for output to the computing device on which the front-end user interface 900 is implemented.

In some examples, the ratings of the disruptive digital health entities may be used in scoring schemes for generating subsequent scoring tables 300a, 300b. In some examples, the ratings may be aggregated with user profile data that can be viewed in back-end user interfaces generated by the output engine 206.

FIG. 10 depicts an example front-end user interface 1000 in accordance with implementations of the present disclosure. The front-end user interface 1000 is generated by the UI generator 216 of the output engine 206 and can be presented on a processing device (e.g., a monitor, a screen, or another display device) of a mobile computing device or a stationary computing device. The front-end user interface 1000 is a search interface that allows a front-end user to search for disruptive digital health entities that are indexed within the data repository 202. The front-end user interface 1000 includes a search bar 1002, a filter menu 1004 (e.g., a drop-down menu), a search icon 1006 a results list 1008, a button 1010 for clearing filters, and a navigation bar 1012 that allows a front-end user to navigate between various user interfaces. The front-end user can enter search terms in the search bar 1002, can use the filter menu 1004 to apply filters to a search, and use the search icon 1006 to initiate a search based on one or both of entered search terms and filters. The results list 1008 displays a list of disruptive digital health entities meeting submitted search criteria. The front-end user can click on a link associated with a disruptive digital health entity to access an assessment interface (e.g., the front-end user interface 900) for assessing the disruptive digital health entity.

FIG. 11 depicts an example front-end user interface 1100 in accordance with implementations of the present disclosure. The front-end user interface 1100 is generated by the UI generator 216 of the output engine 206 and can be presented on a processing device (e.g., a monitor, a screen, or another display device) of a mobile computing device or a stationary computing device. The front-end user interface 1100 provides a front-end user summary with respect to assessments of disruptive digital health entities that are indexed within the data repository 202. The front-end user interface 1100 displays a user login ID 1102, a user type 1104 (e.g., a super user, a power user, a standard user, etc.), a number 1106 of disruptive digital health entities rated over a particular time period (e.g., a week, a month, a year, or since inception), a link 1108 to a listing of disruptive digital health entities to which a user has assigned a special designation, and a navigation bar 1110 that allows a front-end user to navigate between various user interfaces. The front-end user interface 1100 provides user profile information that a front-end user may be interested in viewing.

FIG. 12 depicts an example back-end user interface 1200 in accordance with implementations of the present disclosure. The back-end user interface 1200 is generated by the UI generator 216 of the output engine 206 and can be implemented on a processing device (e.g., a monitor, a screen, or another display device) of a mobile computing device or a stationary computing device. The back-end user interface 1100 is an administrative interface for viewing individual and aggregate user profile data that can include one or more of a user login ID 1202, an administrative status 1204 of a user, a user type 1206 (e.g., a super user, a power user, a standard user, etc.), a time 1208 at which a user last accessed the disruption assessment tool 200, user logins 1210, votes 1212 (e.g., total ratings), Likes 1214 (e.g., positive ratings), Dislikes 1216 (e.g., negative ratings), and Favorites 1218 (e.g., special designations). The back-end user interface 1200 includes an action menu 1220 and a ‘Go’ button 1222 for performing analyses on the user profile data, which may be performed by the evaluation module 212 of the analysis engine 204. For example, ratings may be analyzed according to a type of user (e.g., a power user, a super user, a clinician, an investor, a strategist, etc.) so that ratings provided by users of a certain type can be compared to ratings provided by users of one or more other types. In some examples, ratings may be analyzed according to a type of an organization by which the user is employed or otherwise associated so that ratings provided by users associated with a certain type of organization can be compared to ratings provided by users associated with one or more other types of organizations (e.g., to compare ratings from users associated with healthcare providers to ratings from users associated with healthcare payers). The back-end user interface 1200 can allow a back-end user to easily access user profile information in order to assess a usefulness, a popularity, or an effectiveness of the disruption assessment tool 200 or historical trends and outcomes associated with the disruption assessment tool 200 (e.g., to examine a correlation between user ratings and a success of a disruptive digital health entity, as measured by one or more funding parameters or other parameters).

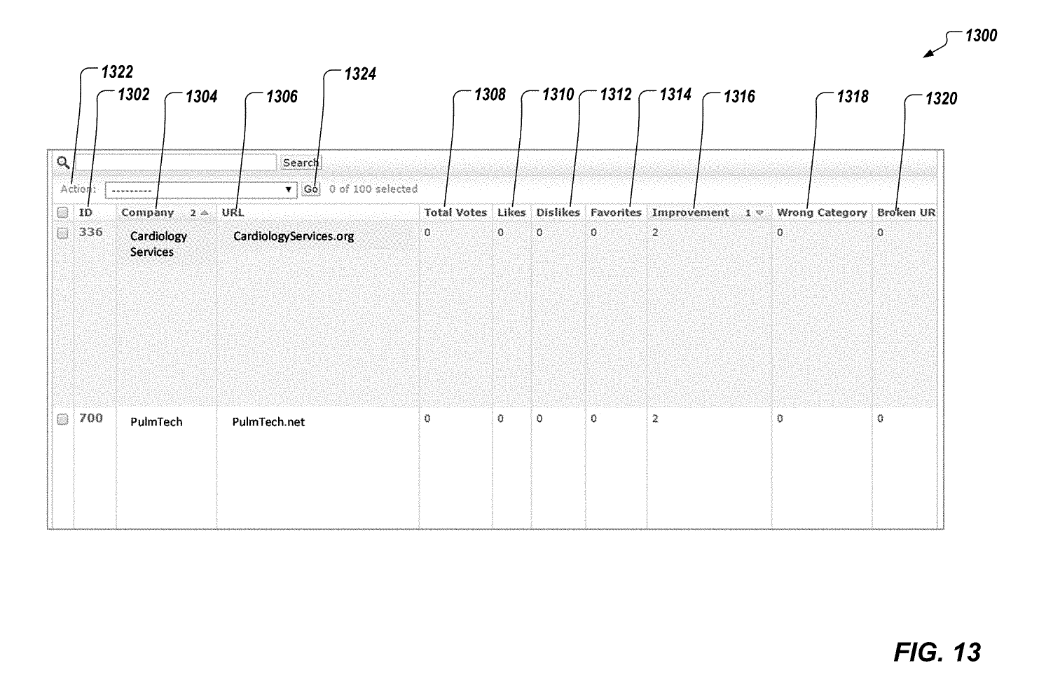

FIG. 13 depicts an example back-end user interface 1300 in accordance with implementations of the present disclosure. The back-end user interface 1300 is generated by the UI generator 216 of the output engine 206 and can be implemented on a processing device (e.g., a monitor, a screen, or another display device) of a mobile computing device or a stationary computing device. The back-end user interface 1300 is an administrative interface for viewing assessment (e.g., rating) data of disruptive digital health entities. The assessment data can include one or more of an ID 1302 (e.g., an index number), a name 1304, a URL 1306, votes 1308 (e.g., total ratings), Likes 1310 (e.g., positive ratings), Dislikes 1312 (e.g., negative ratings), and Favorites 1314 (e.g., special designations), requests 1316 for improved profiles (e.g., profiles 902 of FIG. 9), wrong category counts 1318 (e.g., resulting when a user requests a re-categorization of a disruptive digital health entity), and broken URLs 1320 (e.g., incorrect URLs that need correction). The back-end user interface 1300 includes an action menu 1322 and a ‘Go’ button 1224 for performing analyses on the assessment data, which may be performed by the evaluation module 212 of the analysis engine 204. Example analyses may include creating new types of users, assigning weights to different types of users, modifying user data, removing unclean or noisy data, sorting users by numbers of companies rated, and sorting users by a user type. The back-end user interface 1300 can allow a back-end user to easily access assessment information in order to assess a potential, an overall level of strength, or an overall level of interest of the disruptive digital health entities indexed within the data repository 202 or to identify areas of database improvement for the data repository 202.

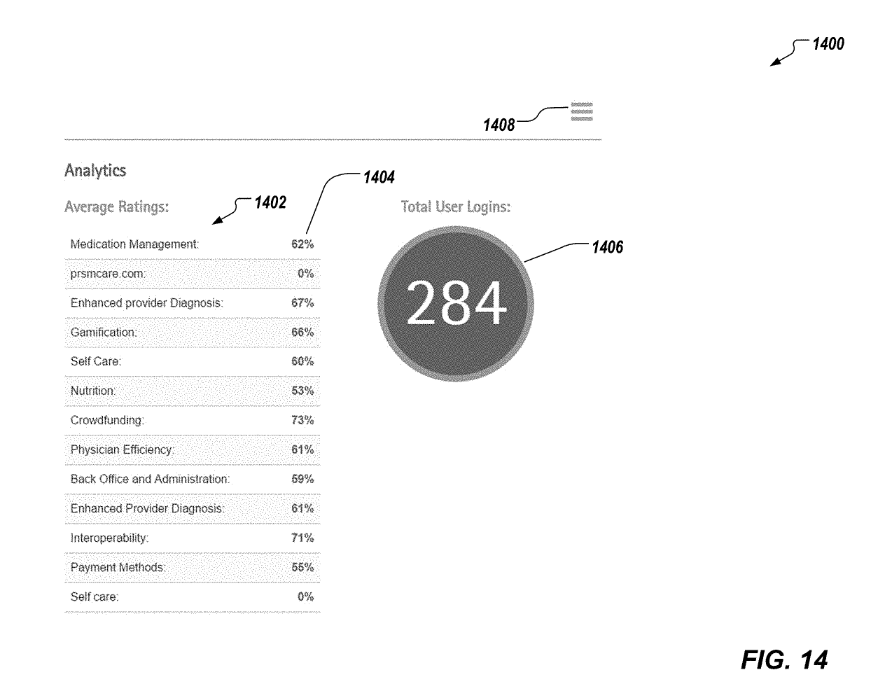

FIG. 14 depicts an example back-end user interface 1400 in accordance with implementations of the present disclosure. The back-end user interface 1400 is generated by the UI generator 216 of the output engine 206 and can be implemented on a processing device (e.g., a monitor, a screen, or another display device) of a mobile computing device or a stationary computing device. The back-end user interface 1400 is an analytical interface for viewing assessment (e.g., rating) data of disruptive digital health entities. The back-end user interface 1400 provides a list of tags 1402, average ratings 1404 (e.g., reflecting an average number of the percentage of positive ratings of disruptive digital health entities associated with the tags), a total number 1406 of user logins into the disruption assessment tool 200, and a navigation bar 1408 that allows a user to navigate between various back-end user interfaces. The back-end user interface 1400 can allow a back-end user to easily access assessment data in order to assess an overall level of user interest in various aspects of the healthcare industry.

In some implementations, the disruption assessment tool 200 can crowdsource user sentiments of multiple disruptive digital health entities that are reflected by assessments entered into front-end user interfaces 900. The assessments may collectively form an information base (e.g., a reference base or a knowledge base) that is stored within the data repository 202. The information base can provide decision-makers within the healthcare industry with insights that can inform important business decisions based on various outputs (e.g., graphical outputs 400, 500, 600, 700, 800) integrated into the front-end user interfaces 900 or other front-end user interfaces outputted by the disruption assessment tool 200.

The front-end user interfaces 900, 1000, 1100, and other user interfaces generated by the disruption assessment tool 200 can provide front-end users with an easy, fun, and interesting way to learn about disruptive digital health entities and to influence related development in the healthcare industry. Furthermore, the front-end user interfaces 900, 1000, 1100, and other user interfaces generated by the disruption assessment tool 200 can instill a sense of community among front-end users who use the disruption assessment tool 200 to offer their inputs on the healthcare industry. The front-end user interfaces 900, 1000, 1100, and other user interfaces generated by the disruption assessment tool 200 can allow front-end users to identify their disruptive digital health entities and, in some examples, survey coworkers for inputs regarding which disruptive digital health entities should receive investment. The front-end user interfaces 900, 1000, 1100, and other user interfaces generated by the disruption assessment tool 200 can also allow front-end users attending conferences to engage with one another or other back-end users of the disruption assessment tool 200 to learn about various disruptive digital health entities. In this manner, the disruption assessment tool 200 can facilitate development of mini-communities sharing common interests.

In some implementations, user interfaces 900, 1000, 1100, 1200, 1300, 1400 generated by the disruption assessment tool 200 present multiple facets of healthcare industry data in easy to understand formats that allow users of the disruption assessment tool 200 to quickly draw conclusions about where to focus investments and organizational efforts. Accordingly, the disruption assessment tool 200 provides a novel technology that assists decision-making regarding digital health initiatives within the healthcare industry via the back-end user interfaces 1200, 1300, and 1400. Furthermore, in some instances, the disruption assessment tool 200 can retrieve supplemental data generated by the analysis engine 204 and stored in the data repository 202, as opposed to repeatedly retrieving raw data from the data repository 202 and reprocessing such data. In this manner, the disruption assessment tool 200 improves the processing speed (e.g., an amount of time required to output a desired result) of the system (e.g., the computing system 100) on which the disruption assessment tool 200 is implemented.

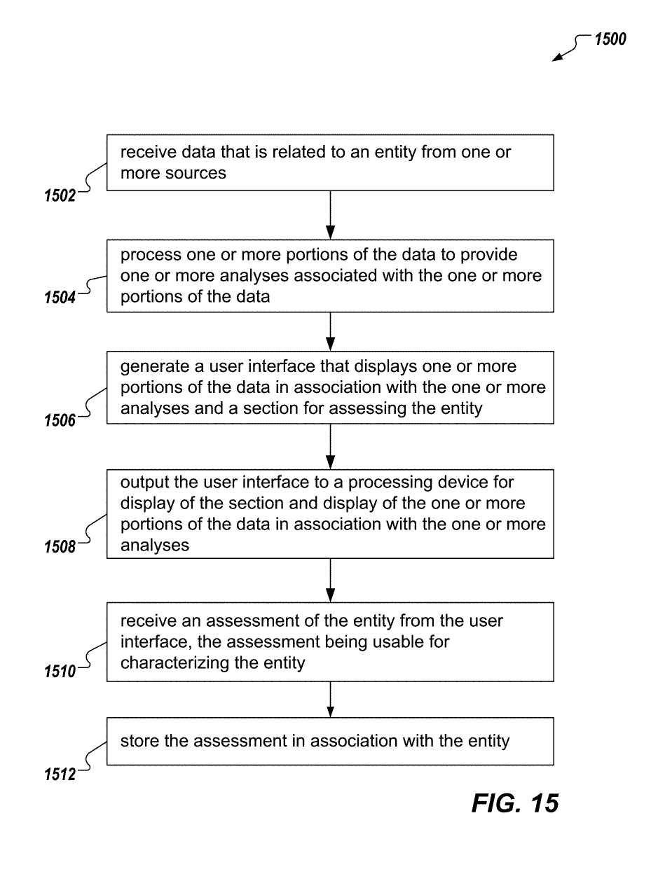

FIG. 15 depicts an example process 1500 that can be performed in implementations of the present disclosure. The example process 1500 can be performed, for example, by the computing system 100 of FIG. 1. In some examples, the example process 1500 can be performed by a system implemented as one or more computer-executable programs on one or more computing devices provided by the server system 104.

Data that is related to an entity is received from one or more sources (1502). For example, profile information and financial information related to a disruptive digital health entity is received in the back-end module 220 of the input engine 208 of the disruption assessment tool 200. The data is stored in the data repository 202. The one or more sources may be a database, a webpage, or a back-end user of the disruption assessment tool 200. In some examples, the data is received according to a predetermined schedule.

One or more portions of the data are processed to provide one or more analyses associated with the one or more portions of the data (1504), and a user interface that displays one or more portions of the data in association with the one or more analyses and a section for assessing the entity is generated (1506). For example, the UI generator 216 of the output engine 206 generates a front-end user interface (e.g., an assessment interface 900) that displays one or more portions of the data in association with one or more tags and a section for assessing the disruptive digital health entity. The section may include a rating selector (e.g., a binary rating selector 912), a comment window (e.g., a comment window 908), or a special designation selector (e.g., a special designation button 910).

The user interface is outputted to a processing device for display of the one or more portions of the data and the tool (1508). For example, the output engine 206 outputs the front-end user interface to a computing device (e.g., a computing device 102 of the computing system 100) for display of the one or more portions of the data and the assessment tool to a front-end user.

An assessment of the entity is received from the user interface, and the assessment is usable for characterizing the entity (1510). For example, a rating, a comment, or a special designation may be received in the front-end module 218 of the input engine 208 from the front-end user interface. The assessment may be based on the one or more portions of the data displayed in the front-end user interface. In some examples, the assessment is a positive rating. In some examples, the assessment is a negative rating.

The assessment is stored in association with the entity (1512). For example, the front-end module 218 sends the rating, the comment, or the special designation to the data repository 202 for storage in association with the disruptive digital health entity.

In some examples, one or more categories (e.g., one or both of sectors and tags) are assigned to the entity by the evaluation module 212 of the analysis engine 204, and the categories are displayed in the user interface. In some examples, scores (e.g., innovation scores and impact scores) of the entity are generated by the evaluation module 212, and a graph (e.g., a scoring matrix) representing the scores are generated by the graphing module 214. The graph may be displayed in the user interface. In some examples, the graphing module 214 generates a graph based on the financial information included within the data, and the one or more portions of the data displayed in the user interface include the graph (e.g., a bar-line graph 500, a bar graph 600, 800, an information map 700, or a chart). In some examples, the UI generator 216 of the output engine 208 generates a back-end user interface (e.g., a back-end user interface 1200, 1300, 1400) displaying one or both of user profile data associated with the assessment and aggregated statistics based on the assessment.

A computer program (also known as a program, software, software application, script, or code) may be written in any appropriate form of programming language, including compiled or interpreted languages, and it may be deployed in any appropriate form, including as a stand-alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatuses may also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any appropriate kind of digital computer. Generally, a processor will receive instructions and data from a read only memory or a random access memory or both. Elements of a computer can include a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer may be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory may be supplemented by, or incorporated in, special purpose logic circuitry.

To provide for interaction with a user, implementations may be realized on a computer having a display device, e.g., a CRT (cathode ray tube) or LCD (liquid crystal display) monitor, for displaying information to the user and a keyboard and a pointing device, e.g., a mouse or a trackball, by which the user may provide input to the computer. Other kinds of devices may be used to provide for interaction with a user as well; for example, feedback provided to the user may be any appropriate form of sensory feedback, e.g., visual feedback, auditory feedback, or tactile feedback; and input from the user may be received in any appropriate form, including acoustic, speech, or tactile input.

Implementations may be realized in a computing system that includes a back end component, e.g., as a data server, or that includes a middleware component, e.g., an application server, or that includes a front end component, e.g., a client computer having a graphical user interface or a Web browser through which a user may interact with an implementation, or any appropriate combination of one or more such back end, middleware, or front end components. The components of the system may be interconnected by any appropriate form or medium of digital data communication, e.g., a communication network. Examples of communication networks include a local area network (“LAN”) and a wide area network (“WAN”), e.g., the Internet.

The computing system may include clients and servers. A client and server are generally remote from each other and typically interact through a communication network. The relationship of client and server arises by virtue of computer programs running on the respective computers and having a client-server relationship to each other.

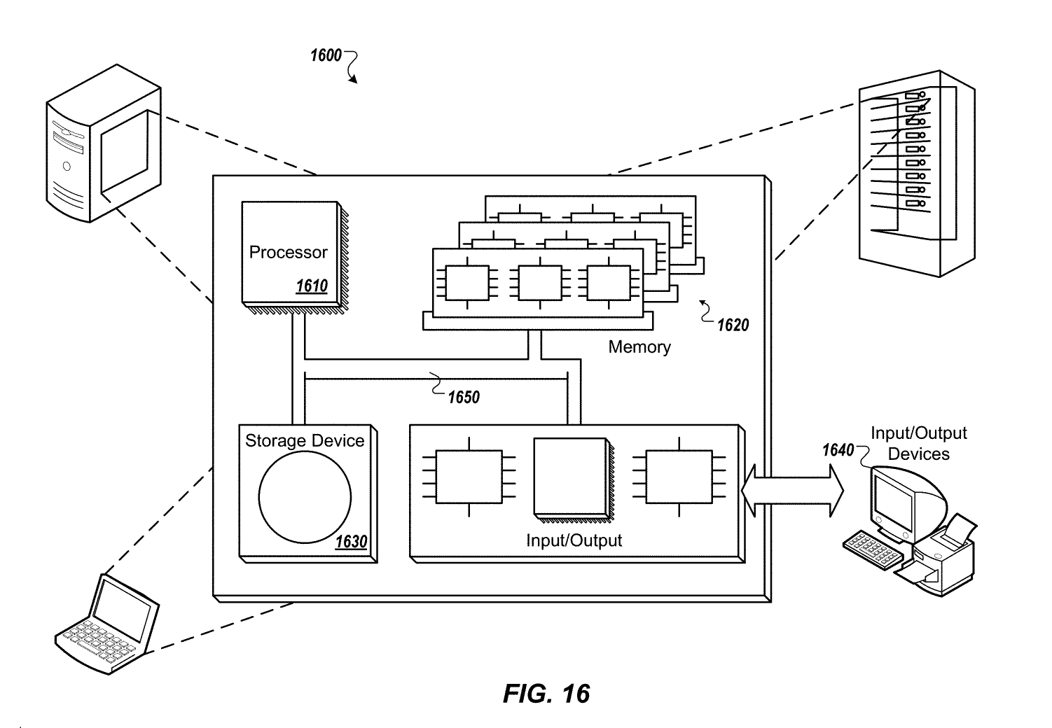

FIG. 16 depicts an example computing system 1600 that can execute implementations of the present disclosure. The computing system 1600 can be used for the operations described in association with any of the computer-implement methods described previously, according to one implementation. The computing system 1600 includes a processor 1610, a memory 1620, a storage device 1630, and an input/output device 1640. Each of the components 1610, 1620, 1630, and 1640 are interconnected using a system bus 1650. The processor 1610 is capable of processing instructions for execution within the computing system 1600. In one implementation, the processor 1610 is a single-threaded processor. In another implementation, the processor 1610 is a multi-threaded processor. The processor 1610 is capable of processing instructions stored in the memory 1620 or on the storage device 1630 to display graphical information for a user interface on the input/output device 1640.

The memory 1620 stores information within the computing system 1600. In one implementation, the memory 1620 is a computer-readable medium. In one implementation, the memory 1620 is a volatile memory unit. In another implementation, the memory 1620 is a non-volatile memory unit.

The storage device 1630 is capable of providing mass storage for the computing system 1200. In one implementation, the storage device 1630 is a computer-readable medium. In various different implementations, the storage device 1630 may be a floppy disk device, a hard disk device, an optical disk device, or a tape device.

The input/output device 1640 provides input/output operations for the computing system 1600. In one implementation, the input/output device 1640 includes a keyboard and/or pointing device. In another implementation, the input/output device 1640 includes a display unit for displaying graphical user interfaces.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

1. A computer-implemented method for capturing assessments, the computer-implemented method being executed by one or more processors and comprising:
receiving, by the one or more processors, back-end data that is related to a disruptive health entity from one or more electronic sources, the back-end data comprising a summary of offerings provided by the disruptive health entity;
processing, by the one or more processors, one or more portions of the back-end data to provide one or more analyses associated with the one or more portions of the back-end data;
after processing the one or more portions of the back-end data, generating, by the one or more processors, a first learning tool comprising a first front-end electronic survey form that displays:
the summary of offerings,
one or more portions of the back-end data in association with the one or more analyses, and
a section for assessing the disruptive health entity, the section comprising a binary rating selector by which a single rating can be submitted for characterizing the disruptive health entity based on multiple elements associated with the disruptive health entity, the multiple elements comprising the summary of offerings, the one or more portions of the back-end data, and the one or more analyses;
outputting, by the one or more processors, the first front-end electronic survey form to a first processing device for display of the summary of offerings, the section, and the one or more portions of the back-end data in association with the one or more analyses;
crowdsourcing, by the one or more processors, first front-end data comprising a first assessment of the disruptive health entity from a first user via the first front-end electronic survey form, the first assessment comprising the single rating based on the multiple elements associated with the disruptive health entity;
storing, by the one or more processors, the one or more analyses and the first assessment in association with the entity within a repository comprising a plurality of crowdsourced assessments to add the first assessment to the plurality of crowdsourced assessments;
after adding the first assessment to the plurality of crowdsourced assessments, generating, by the one or more processors, a first back-end viewer and a second back-end viewer, the first back-end viewer displaying user profile data of a plurality of user accounts and first aggregated statistics as a tabular presentation of vote counts associated with the user profile data and associated with the plurality of crowdsourced assessments, including the first assessment that was added to the plurality of crowdsourced assessments, and the second back-end viewer displaying a graphical presentation of the vote counts;
outputting, by the one or more processors, the first back-end viewer and the second back-end viewer to a second processing device for display of the first aggregated statistics to a second user for assisting the second user in making a strategic determination related to the disruptive health entity;
crowdsourcing, by the one or more processors, second front-end data comprising a second assessment of the disruptive health entity from a third user via a second learning tool comprising a second front-end electronic survey form;
retrieving, by the one or more processors and from the repository, the plurality of crowdsourced assessments, including the first assessment;
generating, by the one or more processors, second aggregate statistics based on the plurality of crowdsourced assessments, including the first assessment, and based on the second assessment; and
generating, by the one or more processors, a third back-end viewer that displays the second aggregate statistics.

2. The computer-implemented method of claim 1, wherein the disruptive health entity comprises a digital health entity.

3. The computer-implemented method of claim 1, wherein the one or more electronic sources comprise a database, a webpage, and a client device at which information is provided by a user.

4. (canceled)

5. The computer-implemented method of claim 1, wherein the section further comprises a comment window.

6. The computer-implemented method of claim 1, wherein the section further comprises a special designation selector.

7. The computer-implemented method of claim 1,
wherein the processing comprises assigning one or more categories to the disruptive health entity,
wherein the back-end data comprises the one or more categories, and
wherein the one or more analyses comprise an assignment of the one or more categories.

8. The computer-implemented method of claim 1, further comprising:
generating scores of the disruptive health entity; and
generating a graphical display representing the scores,
wherein the back-end data comprises the scores, and
wherein the one or more portions of the back-end data displayed in the first front-end electronic survey form comprises the graphical display.

9. The computer-implemented method of claim 8, wherein the graphical display comprises a scoring matrix.

10. The computer-implemented method of claim 1, wherein the back-end data comprises profile information related to the disruptive health entity, and wherein the one or more portions of the back-end data included in the first front-end electronic survey form comprise the profile information.

11. The computer-implemented method of claim 1,
wherein the back-end data comprises financial information related to the disruptive health entity,
wherein the method further comprises generating a graph based on the financial information, and
wherein the one or more portions of the back-end data displayed in the first front-end electronic survey form comprise the graph.

12. The computer-implemented method of claim 11, wherein the graph comprises a bar graph, a bar-line graph, an information map, or a chart.

13. (canceled)

14. (canceled)

15. The computer-implemented method of claim 1, wherein the single rating comprises a positive rating or a negative rating.

16. The computer-implemented method of claim 1, wherein the back-end data is received according to a predetermined schedule.

17. The computer-implemented method of claim 1, further comprising:
receiving a plurality of assessments of respective disruptive health entities; and
generating the first aggregate statistics based on the plurality of assessments.

18. A non-transitory computer-readable storage medium coupled to one or more processors and having instructions stored thereon which, when executed by the one receiving, by the one or more processors, back-end data that is related to a disruptive health entity from one or more electronic sources, the back-end data comprising a summary of offerings provided by the disruptive health entity;
processing one or more portions of the back-end data to provide one or more analyses associated with the one or more portions of the back-end data;
after processing the one or more portions of the back-end data, generating a first learning tool comprising a first front-end electronic survey form that displays:
the summary of offerings,
one or more portions of the back-end data in association with the one or more analyses, and
a section for assessing the disruptive health entity, the section comprising a binary rating selector by which a single rating can be submitted for characterizing the disruptive health entity based on multiple elements associated with the disruptive health entity, the multiple elements comprising the summary of offerings, the one or more portions of the back-end data, and the one or more analyses;
outputting the first front-end electronic survey form to a first processing device for display of the summary of offerings, the section, and the one or more portions of the back-end data in association with the one or more analyses;
crowdsourcing first front-end data comprising a first assessment of the disruptive health entity from a first user via the first front-end electronic survey form, the first assessment comprising the single rating based on the multiple elements associated with the disruptive health entity;
storing the one or more analyses and the first assessment in association with the entity within a repository comprising a plurality of crowdsourced assessments to add the first assessment to the plurality of crowdsourced assessments;
after adding the first assessment to the plurality of crowdsourced assessments, generating a first back-end viewer and a second back-end viewer, the first back-end viewer displaying user profile data of a plurality of user accounts and first aggregated statistics as a tabular presentation of vote counts associated with the user profile data and associated with the plurality of crowdsourced assessments, including the first assessment that was added to the plurality of crowdsourced assessments, and the second back-end viewer displaying a graphical presentation of the vote counts;
outputting the first back-end viewer and the second back-end viewer to a second processing device for display of the first aggregated statistics to a second user for assisting the second user in making a strategic determination related to the disruptive health entity;
crowdsourcing second front-end data comprising a second assessment of the disruptive health entity from a third user via a second learning tool comprising a second front-end electronic survey form;
retrieving from the repository, the plurality of crowdsourced assessments, including the first assessment;
generating second aggregate statistics based on the plurality of crowdsourced assessments, including the first assessment, and based on the second assessment; and
generating a third back-end viewer that displays the second aggregate statistics.

19. A system, comprising:
one or more processors; and
a computer-readable storage device coupled to the one or more processors and having instructions stored thereon which, when executed by the one or more processors, cause the one or more processors to perform operations for capturing assessments, the operations comprising:
processing one or more portions of the back-end data to provide one or more analyses associated with the one or more portions of the back-end data;
after processing the one or more portions of the back-end data, generating a first learning tool comprising a first front-end electronic survey form that displays:
the summary of offerings,
one or more portions of the back-end data in association with the one or more analyses, and
a section for assessing the disruptive health entity, the section comprising a binary rating selector by which a single rating can be submitted for characterizing the disruptive health entity based on multiple elements associated with the disruptive health entity, the multiple elements comprising the summary of offerings, the one or more portions of the back-end data, and the one or more analyses;
outputting the first front-end electronic survey form to a first processing device for display of the summary of offerings, the section, and the one or more portions of the back-end data in association with the one or more analyses;
crowdsourcing first front-end data comprising a first assessment of the disruptive health entity from a first user via the first front-end electronic survey form, the first assessment comprising the single rating based on the multiple elements associated with the disruptive health entity;
storing the one or more analyses and the first assessment in association with the entity within a repository comprising a plurality of crowdsourced assessments to add the first assessment to the plurality of crowdsourced assessments;
after adding the first assessment to the plurality of crowdsourced assessments, generating a first back-end viewer and a second back-end viewer, the first back-end viewer displaying user profile data of a plurality of user accounts and first aggregated statistics as a tabular presentation of vote counts associated with the user profile data and associated with the plurality of crowdsourced assessments, including the first assessment that was added to the plurality of crowdsourced assessments, and the second back-end viewer displaying a graphical presentation of the vote counts;
outputting the first back-end viewer and the second back-end viewer to a second processing device for display of the first aggregated statistics to a second user for assisting the second user in making a strategic determination related to the disruptive health entity;
crowdsourcing second front-end data comprising a second assessment of the disruptive health entity from a third user via a second learning tool comprising a second front-end electronic survey form;
retrieving from the repository, the plurality of crowdsourced assessments, including the first assessment;
generating second aggregate statistics based on the plurality of crowdsourced assessments, including the first assessment, and based on the second assessment; and
generating a third back-end viewer that displays the second aggregate statistics.

20. The computer-implemented method of claim 1, wherein the single rating comprises a non-numerical rating.

21. (canceled)
